(19) United States
(12) Patent Application Publication
(10) Pub. No.: US 2003/0223744 A1
(43) Pub. Date: Dec. 4, 2003

(54) Opening device with self-flipping lid-body

(75) Inventor: Chin-Shu Wu, ChuPei City (TW)

Correspondence Address: BRUCE H. TROXELL, SUITE 1404, 5205 LEESBURG PIKE, FALLS CHURCH, VA, 22041, US

(73) Assignee: AIPTEK INTERNATIONAL, INC.

(21) Appl. No.: 10/159,014

(22) Filed: Jun. 3, 2002

(51) Int. Cl. G03B 17/02

(52) U.S. Cl. 396/536

(57) ABSTRACT

The invention is to provide an opening device with self-flipping lid-body, which includes a shell body, a lid body, a pressing apparatus, and an opening apparatus. The shell body has an accommodation space. One side of the shell body is arranged with a groove hole. The lid body is connected to the shell body by a pivoting manner. The lid body has a wedging hook in corresponding to the groove hole. The lid body chooses that the wedging hook be connected with the groove hole to seal the accommodation space, or choose that the wedging hook be separated from the groove hole to open the accommodation space. The pressing apparatus is connected to the shell body and has a pivoting axis that be activated by touching off. The opening apparatus is connected to the pressing apparatus and has a convex block in corresponding to the groove hole. The wedging hook is separated from the groove hole by making the convex block abutted and contacted with the wedging hook.

### FIELD OF THE INVENTION

The invention relates to an opening device with self-flipping lid-body, more particularly to an opening device with self-flipping lid body that be arranged on the pressing apparatus of camera for opening the battery lid of camera.

### BACKGROUND OF THE INVENTION

In the modern society of flouring science and technology, every item of industry and livelihood appliances is all developed toward the direction of high-tech. Consequently, its manufactured product is also aimed at the targets of lightness-and-smallness, delicate accuracy and reliable beauty. However, in the mean time when these products are renewed continuously and provide the consumer the latest and best choice, they emphasize accurate and reliable quality, so the problems of difficulties for manufacture and assembly are also raised. This is why the price of high-tech product is so high, especially for the electronic product.

Among the electronic products, the digital camera not only has extremely small size, but also is suitable for putting in the pocket to carry, so it creates a lot of favorite consumers relatively. Negative film is not needed for the prior digital camera, so time and expanse for developing the negative film be saved, which is a big revolution for the livelihood appliances. But, the power source of the digital camera is supplied by arranging battery for convenience and, in the consideration of preventing the battery from dropping and the beauty of camera, a covering lid is arranged for sealing and fixing the battery, but the covering lid has to be opened directly by hand. When the battery is needed for changing, it is preferable for the user with long fingernail or tool to open the covering lid of battery. This kind of apparatus not only creates inconvenience, but also creates damage when the opening tool is used improperly. Therefore, the covering lid of battery for the digital camera sold in current market is designed with an opening apparatus for opening the covering lid easily. In order for the user to apply force to lift up the opening apparatus, the opening apparatus is usually arranged on the outer side surface of the covering lid. For the convenience of activation, the opening apparatus must have specific size, such that the size of digital camera is increased, which is contradicted to the objective of smallness-and-lightness of electronic product, besides it is very inconvenient in manufacture and assembly, so this is not an optimum solution. How to solve this problem and reduce the cost of manufacturer are the urgent request and the needed improvement for the relative business.

### SUMMARY OF THE INVENTION

The main objective of the invention is to provide an opening device with self-flipping lid-body, in which the opening device is connected to a pressing apparatus for facilitating the user to open the covering lid of battery of the camera and facilitating the functions of manufacture, assembly and formation.

To achieve above objective, the opening device with self-flipping lid-body according to the present invention includes a shell body, a lid body, a pressing apparatus, and an opening apparatus.

The shell body has an accommodation space, which is capable of providing at least one battery, and one side of the shell body is arranged with a groove hole.

The lid body is connected to the shell body by a pivoting manner, and the lid body has a wedging hook in corresponding to the groove hole. The lid body chooses that the wedging hook be connected with the groove hole to seal the accommodation space, or choose that the wedging hook be separated from the groove hole to open the accommodation space.

The pressing apparatus is connected to the shell body and has a pivoting axis that be activated by touching off and, by touching off the pivoting axis, it proceed a shutter photograph of camera or proceed a switch of photograph mode of camera.

The opening apparatus is connected to the pressing apparatus and has a convex block in corresponding to the groove hole. The wedging hook is separated from the groove hole by making the convex block abutted and contacted with the wedging hook.

For your esteemed reviewing committee members to understand and recognize the invention, a detailed description matched with corresponding drawings is presented as follows.

### BRIEF DESCRIPTION OF THE DRAWINGS

FIG. 1 is an explosive illustration of three-dimensional structure for the preferable embodiment of the opening device with self-flipping lid-body according to the invention in matching with a camera.

FIG. 2 is an assembly illustration of three-dimensional structure for the preferable embodiment of the opening device with self-flipping lid-body according to the invention in matching with a camera.

FIG. 3A is an illustration for the poking-and-opening action of the preferable embodiment of the opening device with self-flipping lid-body according to the invention.

FIG. 3B is an illustration for the recovering action of the preferable embodiment of the opening device with self-flipping lid-body according to the invention.

### DETAILED DESCRIPTION OF THE INVENTION

The main technical spirit of the invention is to arrange an opening apparatus that is brought along in a pressing apparatus of camera, so that it provide an opening function additionally for the pressing apparatus of camera.

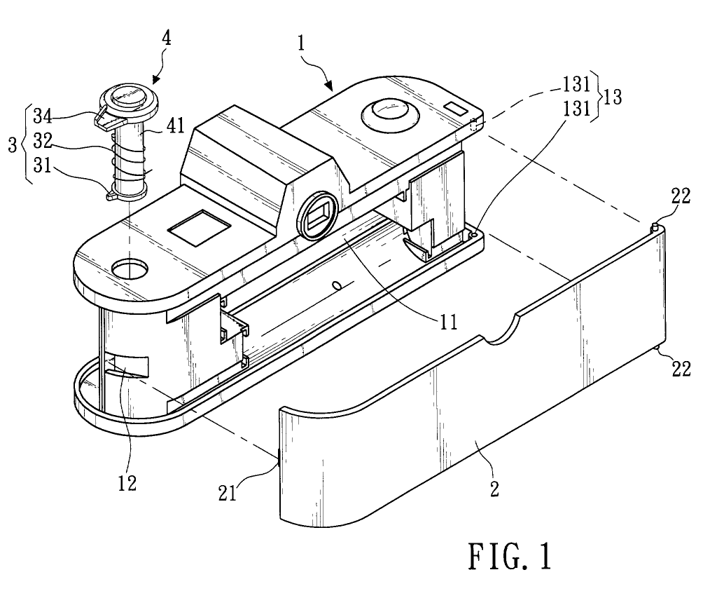

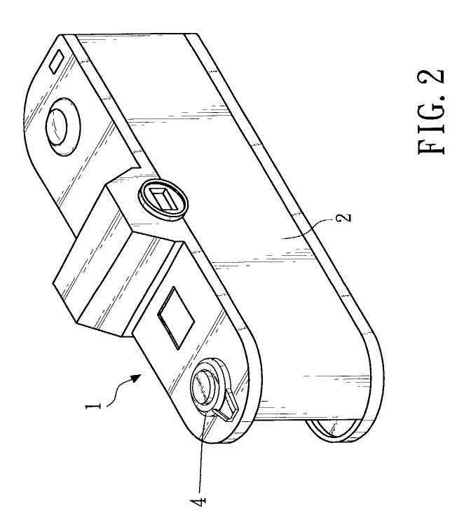

Please refer to FIG. 1 and FIG. 2, which are the illustrations for the three-dimensional structure of the preferable embodiment for the opening device with self-flipping lid-body according to the present invention in matching with a camera. In this preferable embodiment according to the invention, the opening device with self-flipping lid-body includes a shell body 1, a lid-body 2, a pressing apparatus 4, and an opening apparatus 3. The shell body 1 is the main body constituting the camera and is injected out and formed into one body from the materials of plastics or its compound. The shell body 1 has an accommodation space 11, which provide at least one battery 1. In this preferable embodiment of the invention, the number of arrangement of battery is two and, of course, the number of battery also is one or more than three. Such kind of variation of number be varied and executed by those who are skilled in such arts according to above disclosure and this variation still keeps the merits of the invention and also is within the spirit and scope of the invention, so a detailed description is not presented herein any more. Two sides of the shell body 1 are respectively arranged with a groove hole 12 and a pivoting-and-connecting part 13.

In the preferable embodiment of the invention, the lid body 2 is injected out and formed into one body from the materials of plastics and its compound. The lid body 2 has at least one convex edge 22 that is matched and connected with a concave hole 131 in corresponding to the pivoting-and-connecting part 13, so that the lid body 2 is connected to the shell body 1 by a pivoting-and-connecting manner and can proceed a rotating motion by taking this structure as an axis. Of course, it also be that the lid body 2 has concave hole and the pivoting-and-connecting part 13 is arranged with convex edge correspondingly, or the lid body 2 has a concave hole and a convex edge and the pivoting-and-connecting part 13 is arranged with a convex edge and a concave hole correspondingly. These two arrangements all make the lid body 2 precede a rotating motion by taking such structure as an axis. Such kind of variation of structural combination of concave and convex be varied and executed by those who are skilled in such arts according to above disclosure, but this kind of variation still keeps the merits of the invention and is also within the spirit and scope of the invention, so a detailed description is not presented herein any more. Another free end of the lid body 2 has a wedging hook 21 in corresponding to the groove hole 12. Therefore, the lid body 2 chooses that the wedging hook 21 is connected with the groove hole 12 to seal the accommodation space 11, or it choose that the lid body 2 can proceed rotating motion to separate the wedging hook 21 and the groove hole 12 to open the accommodation space 11.

The pressing apparatus 4 is connected to the shell body 1 and has a pivoting axis 41. By touching off the pivoting axis with an application of force, the operator proceed a shutter photograph of camera to pick up the images of the objects to be photographed, or proceed a switch of photograph mode of camera to reach the function of picking up images of the objects to be photographed with the variation of high resolution or low resolution.

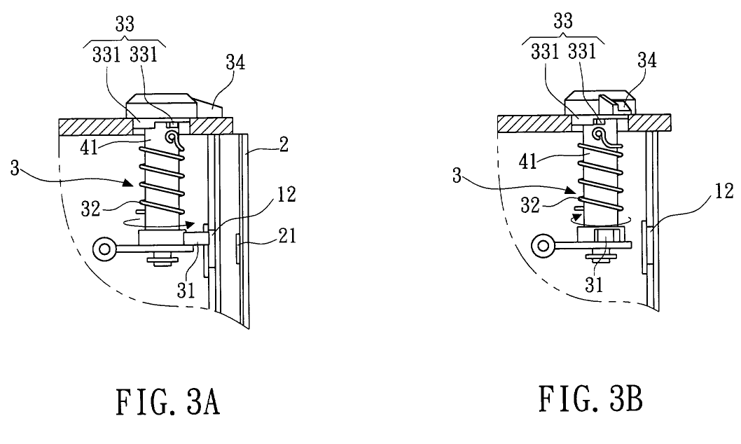

In the preferable embodiment of the invention, the opening apparatus 3 is connected to the pressing apparatus 4 and is located on the pivoting axis 41. One end of the opening apparatus 3 has a convex block 31 in corresponding to the groove hole 12. Another end of the opening apparatus 3 is arranged with a poking block 34, with which the operator pokes by applying a force. In order to make an active illustration to understand the invention in more detailed way, please refer to FIG. 3A and FIG. 3B, which are the activation illustrations for the preferable embodiment for the opening device with self-flipping lid-body according to the invention. When the operator pokes the poking block 34 with force, the opening apparatus 3 proceed rotation by taking the pivoting axis 41 as a rotation axis to make the convex block 31 abutted and contacted with the wedging hook 21 and make the wedging hook 21 separated from the groove hole 12. The lid body 2 makes a rotation motion to open the accommodation space (not shown in the figure) by taking the pivoting-and-connection part (not shown in the figure) as a rotation axis. At this time, when the operator releases the poking block 34, since the opening apparatus 3 is arranged with an elastic element 32 that is connected to the shell body 1, so the elastic force of the elastic element 32 make the opening apparatus 3 proceed a rotation motion by taking the pivoting axis 41 as a rotation axis. After the opening apparatus 3 proceeds a rotation motion with an appropriate angle by taking the pivoting axis 41 as a rotating axis, the opening apparatus 3 has a positioning apparatus 33 for providing a fixation function to the opening apparatus 3. In the preferable embodiment of the invention, the positioning apparatus 33 is positioned by making two convex points 331 abutted to each other. Of course, it also can be one convex point and one concave point. Such kind of variation of combination of concave and convex points be easily varied and executed by those who are skilled in such arts according to above disclosure, but this variation still keeps the merits of the invention and is also within the spirit and scope of the invention, so a detailed description is not presented herein any more.

In summarizing above description, the opening device with self-flipping lid-body according to the invention indeed reach the function for the user to open the battery lid of camera with ease and the functions of manufacture, assembly, and formation with convenience, by connecting the opening apparatus to a pressing apparatus, and it can really overcome the shortcomings of the prior arts, satisfy the request of relative industry, and enhance their competition ability.

Moreover, the preferable embodiments described in above section are to illustrate the invention in a detailed way and are not limitations to the scope of the invention. Those who are skilled in such arts should understand that their appropriate and slight variation and modification still keep the merits of the invention and are also within the spirit and scope of the invention.

In summary, the solidification of execution of the invention is really fulfilled the patent essence of invention regulated in the patent law, so please your esteemed reviewing committee review this patent application in a favorable manner and permit it as a formal patent wishfully.

What is claimed is:

1. An opening device with self-flipping lid-body, comprising:
a shell body, which has an accommodation space, and two sides of the shell body each is arranged with a groove hole and a pivoting-and-connecting part respectively;
a lid-body, which is connected to the pivoting-and-connecting part and has a wedging hook in corresponding to the groove hole, and the lid body choose that the wedging hook is connected to the groove hole to seal the accommodation space, or choose that the wedging hook is separated from the groove hole to open the accommodation space; and
an opening apparatus, which is connected to the shell body and has a convex block in corresponding to the groove hole to make the wedging hook separated from the groove hole by making the convex block abutted and contacted with the wedging hook.

2. The opening device with self-flipping lid-body according to claim 1, wherein the opening apparatus has an elastic element connected to the shell body to make the convex block separated from the wedging hook by the elastic force of the elastic element.

3. The opening device with self-flipping lid-body according to claim 1, wherein the opening apparatus has a positioning apparatus, which provide the convex block to be separated from the wedging hook for fixing the opening apparatus.

4. The opening device with self-flipping lid-body according to claim 1, wherein the opening apparatus is arranged with a poking block, and it make the convex block abutted and contacted with the wedging hook by applying a force on the poking block.

5. An opening device with self-flipping lid-body, comprising:
a shell body, which has an accommodation space that provide to accommodate at least one battery, and one side of the shell body is arranged with a groove hole;
a lid body, which is connected to the shell body by a pivoting-and-connecting manner and has a wedging hook in corresponding to the groove hole, and the lid body choose that the wedging hook is connected with the groove hole to seal the accommodation space, or choose that the wedging hook is separated from the groove hole to open the accommodation space;
a pressing apparatus, which is connected to the shell body and has a pivoting axis that can be activated by touching off; and
an opening apparatus, which is connected to the pressing apparatus and has a convex block in corresponding to the groove hole, and it makes the wedging hook separated from the groove hole by making the convex block abutted and contacted with the wedging hook.

6. The opening device with self-flipping lid-body according to claim 5, wherein the opening apparatus has an elastic element connected to the shell body to make the convex block separated from the wedging hook by the elastic force of the elastic element.

7. The opening device with self-flipping lid-body according to claim 5, wherein the opening apparatus has a positioning apparatus, which provide the convex block to be separated from the wedging hook for fixing the opening apparatus.

8. The opening device with self-flipping lid-body according to claim 5, wherein the opening apparatus is arranged with a poking block, and poking the poking block make the opening apparatus proceed a rotating motion by taking the pivoting axis as a rotating axis, and it make the convex block abutted and contacted with the wedging hook.

9. The opening device with self-flipping lid-body according to claim 5, wherein it precede a shutter photograph of camera by touching off the pivoting axis.

10. The opening device with self-flipping lid-body according to claim 5, wherein it precede a switch of photograph mode of camera by touching off the pivoting axis.
